(19) United States
(12) Patent Application Publication
(10) Pub. No.: US 2015/0016027 A1
(43) Pub. Date: Jan. 15, 2015

(54) ELECTRICAL DISTRIBUTION SYSTEM

(71) Applicant: Bill Leahy, Selma, OR (US)

(72) Inventor: Bill Leahy, Selma, OR (US)

(21) Appl. No.: 13/941,780

(22) Filed: Jul. 15, 2013

(51) Int. Cl. H02B 1/52; H02B 1/28; H02B 3/00; H02H 3/16

(52) U.S. Cl. CPC H02B 1/52; H02H 3/16; H02B 1/28; H02B 3/00
USPC 361/625; 29/825

(57) ABSTRACT

A portable electrical power distribution assembly using a bucket as a structural supporting element. A power socket and at least one power receptacle are mounted to the bucket. The power socket and power receptacle are electrically connected to establish a complete circuit such that when power is connected to the power socket, the power receptacles are energized. The components of the circuit is mounted to one of the peripheral wall or the lid of the bucket. Components of a second circuit may be mounted to the other one of the peripheral wall or the lid. The power receptacle may be of the GFI type. The bucket may include a bail handle. Ballast weights may be placed in the bucket to maintain the bucket upright with the open end of the bucket facing upwardly. Individual buckets may be modules of a stacked assembly.

### FIELD OF THE INVENTION

The present invention relates to electrical receptacles, for all weather and conditions, and more particularly to a multiple power distribution assembly including a GFCI/GFI to protect all receptacles enabling ready connection of power cords with protect and providing power to electrical tools and equipment of all kinds; for the safety of all people working in all weather conditions.

### BACKGROUND OF THE INVENTION

Many projects such as home owners, new construction, remodeling of existing buildings, and for the safety for the people in all weather and conditions, the like require onsite electrical power distribution to enable the use of more power tools and other electrical equipment. For various reasons, most of the time there is a shortage of energized electrical receptacles or outlets available. In the example of construction projects, it may not be possible to provide an operable electrical distribution system until a certain minimum portion of the building constructed is complete. Yet power may be required to power electrical tools, to provide lighting, and for other purposes merely to bring the building to the point where electrical distribution circuits and receptacles are available. Another example is a home owner needing more outlet do a job in the backyard.

Power may be available from portable generators or even from a utility connection at the site. However, suitable distribution circuits may not be available. Extension cords and other impromptu measures have been utilized to meet the need to connect power from a source to electrical equipment. But many are not made for all weather and all conditions.

Such impromptu measures entail certain hazards, such as exposure of receptacles, wired connections, and exposed conductors to incidental and unintended contact, to water such as rain water which may be present, and other hazardous conditions which may be present. This is particularly true on construction sites, where an uncompleted or partially completed building does not afford suitable protection to impromptu electrical supply circuitry, and home owners working around their home.

There exists a need for providing convenient power receptacles where electrical distribution facilities have not been provided, and for rendering temporary power facilities resistant to frequently encountered hazards, including exposure to incidental contact with water, personnel, tools and materials, and other potential causes of electric shock and unintended grounding of power.

### SUMMARY OF THE INVENTION

The present invention addresses the above stated needs by providing a convenient, portable, practical apparatus for making electrical power available on premises lacking a convenient permanent power distribution system including energized electrical receptacles. The apparatus uses a conventional bucket as a structural support and protective housing for electrical receptacles, and keeping the power 2 feet off the ground. The bucket is inherently water resistant and resistant to casual penetration by tools and materials, and to inadvertent contact by people's hands or other parts of the body. Buckets are widely available and readily modified to accommodate electrical distribution components, but not limited to just buckets of one shape and size, all of these are made to sit on any standard buckets, such as power sockets for connecting an energized power cord, receptacles for enabling ready connection of power cords of electrical appliances, and internal wiring connecting the power sockets to the receptacles.

Power sockets and receptacles may be mounted on either or both of the receptacle portion of the bucket, or just the lid of the bucket as it's own distribution unit. The bucket may include a bail type handle or other types of handles for ready grasping and carrying.

Buckets modified to include power circuitry may be vertically stacked to provide tall modular power distribution assemblies presenting a large number of power receptacles for use. A bottom or base module may comprise a bucket devoid of electrical components and circuitry, for receiving ballast weights. The base module may elevate powered modules safely above the ground, away from potential hazards such as rain puddles, for example. But not limited to the bucket, may have a stand with a weighted base and a tower of any shape and size to hold every thing outlet and even a circuit breaker panel.

The present invention provides improved elements and arrangements thereof by apparatus for the purposes described which are inexpensive, dependable, and fully effective in accomplishing their intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a bucket adapted to enable distribution of electric power, with a power socket and receptacles located on a lateral surface of the bucket, according to at least one aspect of the invention.

FIG. 2 is a top plan view of the bucket of FIG. 1, with the lid removed to reveal internal detail.

FIG. 3 is a perspective view of a bucket adapted to enable distribution of electrical power, with a power socket and receptacles located on a lid of the bucket, according to at least one aspect of the invention.

FIG. 4 is an exploded view of the bucket of FIG. 3, with the lid tilted to provide a view of mounting and connection of components mounted thereon.

FIG. 5 is a perspective detail view of a lid of a bucket, shown with an optional water resistant protective cover.

FIG. 6 is a perspective view of an alternative form of buckets which may be utilized in a bucket adapted to enable distribution of electric power.

FIG. 7 is a side view of a stack of buckets adapted to enable distribution of electrical power, shown partially in cross section, and partially broken away to reveal internal detail.

### DETAILED DESCRIPTION

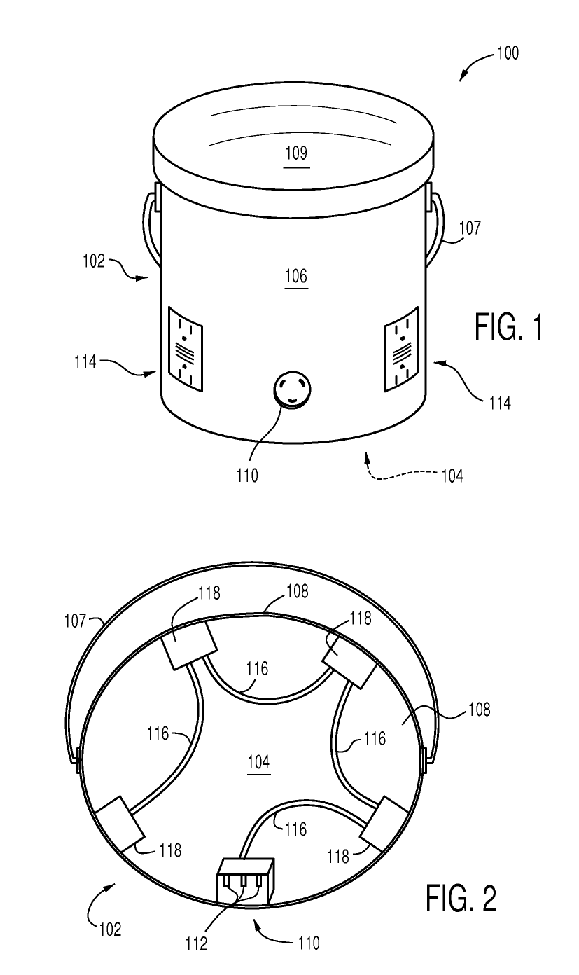

Referring first to FIGS. 1 and 2, according to at least one aspect of the invention, there is shown an electrical power distribution assembly 100 which includes a bucket 102. The bucket 102 may be of a widely available type made from a synthetic polymer and having a floor 104, a peripheral wall 106 projecting upwardly from the floor 104, and optionally, including a bail handle 107.

It should be noted at this point that orientational terms such upright and upwardly refer to the subject drawing as viewed by an observer. The drawing figures depict their subject matter in orientations of normal use, which could obviously change with changes in body posture and position. Therefore, orientational terms must be understood only to provide semantic basis for purposes of description.

Moreover, the term bucket 102 may be different containers and is used to describe a non-limiting example of the invention. In fact, the invention may be any suitable vessel.

The bail handle 107 may be conventional, being pivotally fixed to the peripheral wall, to facilitate carrying the bucket 102 by hand. The bucket encloses an open interior 108 (visible in FIG. 2), defined above the floor 104 and within the peripheral wall 106. A removable lid 109 frictionally or interferingly engages the peripheral wall 106 to close the open interior 108, thereby protecting internal components of the electrical power distribution assembly 100 from hazardous contact with, for example, falling water, and incidental mechanical contact with foreign objects.

A power socket 110 is mounted to the peripheral wall 106. The power socket 110 includes electrically conductive prongs 112, the prongs 112 exposed to the exterior of the bucket 102 for ready installation of a female terminal of a power conductor (not shown). The power socket 110 may be arranged such that the prongs 112 are recessed below the outer surface of the peripheral wall 106. Alternatively stated, the prongs may be recessed into the open interior 108, thereby being partially protected from incidental contact with foreign objects. The power conductor may be a conventional electrical extension cord for example.

At least one power receptacle 114 is mounted to the peripheral wall 106. Preferably, and as shown, a plurality of power receptacles 114 are provided. This enables a plurality of electrical appliances (none shown) to be powered from the electrical power distribution assembly 100. Also, connection of a power cord (not shown) for an electrical appliance may be connected to a receptacle 114 from any one of a number of directions. Thus, the electrical power distribution assembly 100 need not be rotated or otherwise reoriented to facilitate convenient connection of power when connecting a power cord to power. The power receptacle 114 may be of a conventional duplex type including recessed power conductors (not shown) exposed to the exterior of the bucket 102 for ready insertion of a male power terminal of an electrical supply cord (not shown).

Although it would be possible to mount the power receptacles 114 directly to the peripheral wall 106, it is preferred to mount an electrical work box 118 to the peripheral wall 106 in the interior 108 of the bucket 102. As shown in FIGS. 1 and 2, each power receptacle 114 is installed within an associated electrical work box 118, thereby being indirectly mounted to the peripheral wall 106. Of course, a plurality of power receptacles 114 could be ganged together within a single workbox 118 if desired. The power receptacle 114 may include an electric circuit protective device, such as a fuse (not shown), a circuit breaker which is responsive to magnitude of electrical current (not shown), or a ground fault interrupter (as shown), which is responsive to imbalance or unequal magnitude in electrical currents in the legs of the protected circuit.

Power conductors 116 are connected among the power socket 110 and the power receptacles 114 to establish a power circuit electrically connecting the power socket 110 to each power receptacle 114. As employed herein, power conductors such as the power conductors 116 will be understood to include the number and arrangement required for operability, including at a minimum establishing continuity between the power socket 110 and each power receptacle 114. Notably, at least two conductors are provided as part of each illustrated power conductor 116 to establish a complete circuit. Power conductors 116 may include a ground conductor, apart from ordinarily energized individual conductors. The power conductors 116 are contained in a protected location within the bucket 102.

In the exemplary electrical power distribution assembly 100 of FIGS. 1 and 2, the power circuit including the power socket 110, the power receptacles 114, and the power conductors 116 are mounted only to the peripheral wall 106. This enables the lid 109 to be removed from the peripheral wall 106 without requiring dismantling of any part of the power circuit.

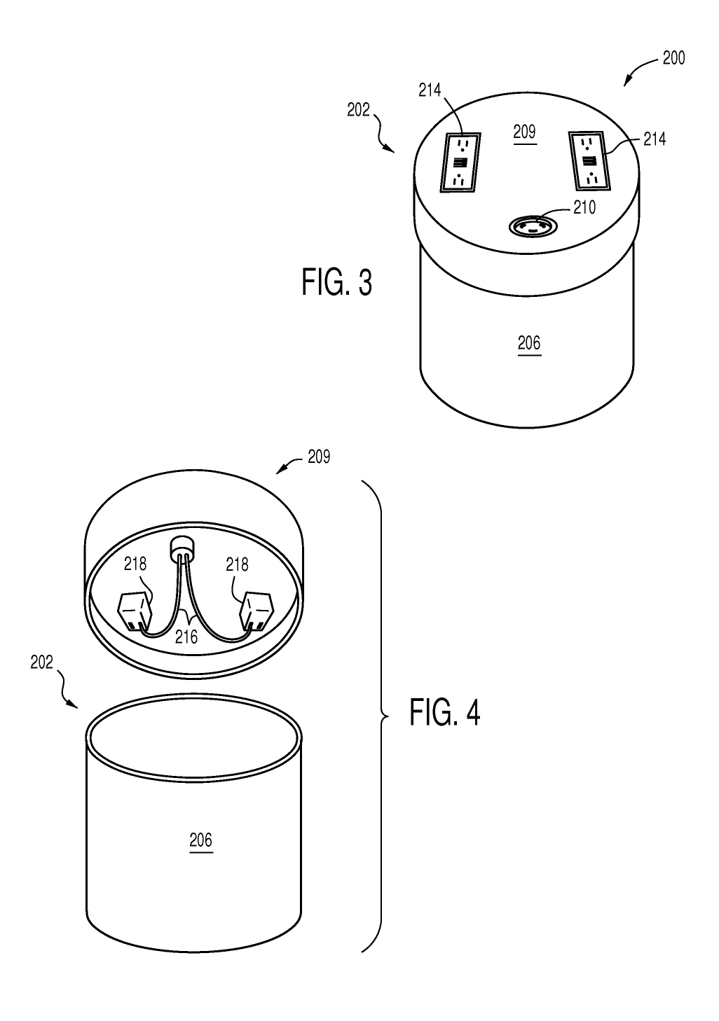

Turning now to FIGS. 3 and 4, an electrical power distribution assembly 200 includes a bucket 202 and a power circuit mounted to only a lid 209 of the bucket 202. As is the case with the electrical power distribution assembly 100, the lid 209 may be removed from the peripheral wall 206 of the bucket 202 without requiring dismantling of the power circuit.

The bucket 202 may be the structural and functional equivalent of the bucket 102 of FIGS. 1 and 2, and need not be further described. The power circuit mounted to the lid 209 includes a power socket 210, a plurality of power receptacles 214, and power conductors 216, which may be structural and functional equivalents of their similarly named counterparts of FIGS. 1 and 2, apart from being mounted to the lid 209, and hence need not be further described. The power receptacles 214 may be mounted in work boxes 218, thereby being indirectly mounted to the lid 209, rather than being mounted directly to the lid 209.

In the respective examples of FIGS. 1 and 3, the respective power socket 110 or 210, the respective power receptacles 114 or 214, and the respective power conductors 116 or 216 of any one power circuit are mounted to only one of the respective peripheral wall 106 (FIG. 1) or the lid 209 (FIG. 4). In an unillustrated example according to a further aspect of the invention, it would be possible to provide a first power circuit having components mounted to the peripheral wall (e.g, the peripheral wall 106 of FIG. 1), and a second power circuit having components mounted to the lid (e.g., the lid 209 of FIG. 3). In this unillustrated example, because the respective power circuits have components mounted to only one of the lid and the peripheral wall, the lid may be removed from its associated bucket without requiring dismantling of any part of the two independent power circuits.

Prongs of a power socket, such as the prongs 112 of the power socket 110, of the example of FIG. 3 and of the example wherein power circuits are provided both at the peripheral wall of the bucket (e.g., the peripheral wall 106) and also at the lid (e.g., the lid 209 of FIG. 3), may be recessed as seen in FIG. 2. In these examples of the invention, recessing is below the outer surface of the bucket or of the lid or both.

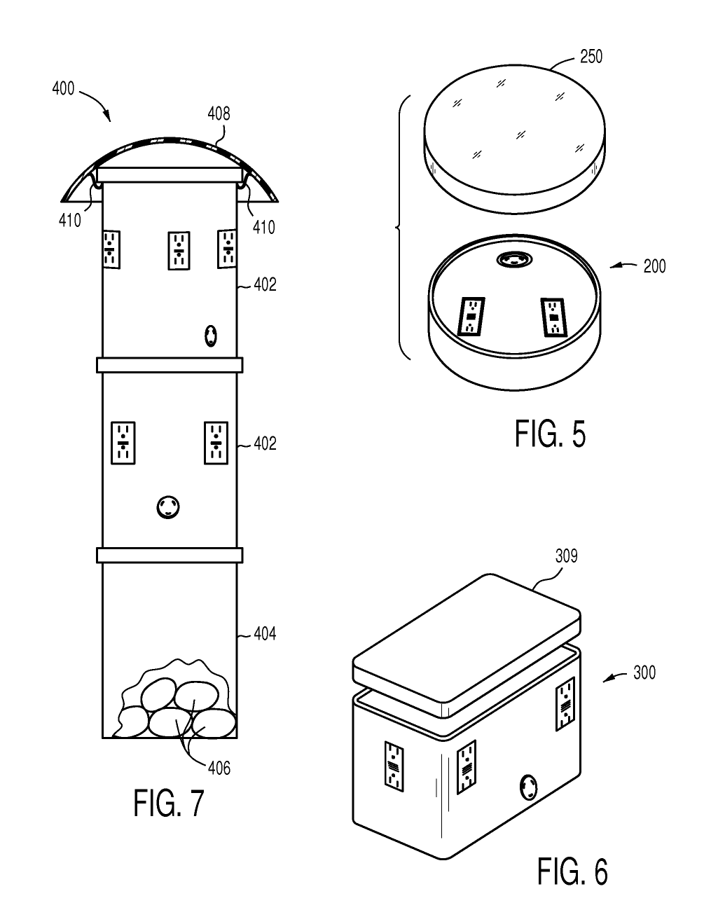

FIG. 5 shows an optional translucent, liquid resistant cover 250 which is configured to fit to a bucket, such as by engaging the lid 209 of the bucket 202 (see FIG. 3). The liquid resistant cover 250 may be just large enough to receive the lid 209 in close interfit therewith, thereby retaining the lid 209 when the liquid resistant cover 250 is manually placed thereover and pressed into engagement therewith.

Alternatively, each power socket 210 and power receptacle 214 may have individual translucent liquid resistant covers as known in the art. The covers would be used to protect the electrical power distribution assembly 100 from water or any other debris. In addition, the covers would protect children, pets, or any other foreign objects from entering the invention and causing harm. Once the user decides to use a particular power receptacle 214, then the particular cover may be removed in order to provide access.

FIG. 6 shows an alternative form of a bucket 300, which is essentially a parallelepiped. A lid 209 has corresponding configuration, to enable conventional interfit therewith. The bucket 300 may, apart from its external configuration, have all of the structure and functions, such as electrical components and electrical connections, of the bucket 209, for example.

FIG. 7 shows a modular electrical power distribution assembly 400, made up from a plurality of electrical power modules 402 and a base module 404, which electrical power modules 402 and the base module 404 are configured to interengage one another to form a vertical stack of plural modules 402, 404. Each of the electrical power modules 402 may be similar or identical to the electrical power distribution assembly 100, for example. The base module 404 may utilize a bucket similar to that used to form the modules 402, but is devoid of electrical components and electrical circuitry. The base module 404 may be empty, to accommodate receiving ballast weights, such as stones 406. Use of a base module such as the base module 404 including the ballast weights improves stability of the stacked modules 402 forming the electrical power distribution assembly 400. Also, electrical power modules 402 are upwardly displaced by the base module 404, thereby being elevated above the ground (not shown). This may improve safety by elevating energized electrical components above sources of water, such as rain puddles, which might otherwise present shock hazards and undesirable tripping of protective features such as ground fault interrupters.

FIG. 7 also shows an optional water resistant cover 408, which laterally overhangs the bucket forming its associated electrical power module 402. The water resistant cover 408 may be domed as shown, and may include clips 410 disposed to engage the lid of the bucket forming the electrical power module 402.

According to a further aspect of the invention, a method of providing temporary power distribution may include installing a power socket in a bucket, with the power socket exposed for manual installation of a supply power cord thereto from the exterior of the bucket. The bucket and power socket may be the bucket 102 and the power socket 116 of FIG. 1 for example. The method may include installing a plurality of power receptacles (e.g., the power receptacles 114) in the bucket, with the power receptacles exposed for manual connection of power cords of electrical appliances thereto from the exterior of the bucket. The method may include establishing a power circuit operably connecting the power receptacles to the power socket. The method may include orienting the bucket on a supporting environmental surface with the open end of the bucket facing upwardly. The method may include placing at least one ballast weight in the bucket. The ballast weight may include bricks, stones, sand, and other relatively dense, readily available materials (none shown). The method may include installing an energized power cord in the power socket.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1. An electrical power distribution assembly, comprising:
a vessel having a floor, a peripheral wall projecting upwardly from the floor, an open interior above the floor and within the peripheral wall, and a lid which removably frictionally engages the peripheral wall to close the open interior;
a power socket mounted to a selected one of the peripheral wall and the lid, the power socket including electrically conductive prongs exposed to the exterior of the vessel for ready installation of a female terminal of a power conductor;
at least one power receptacle mounted to the selected one of the lid and the peripheral wall, the power receptacle including recessed power conductors exposed to the exterior of the vessel for ready insertion of a male power terminal of an electrical supply cord; and
power conductors establishing a power circuit electrically connecting the power socket to each power receptacle, the power conductors contained within the vessel, wherein the power socket, the power receptacle, and the power conductors of any one power circuit are mounted to only one of the peripheral wall and the lid, thereby enabling the lid to be removed from the peripheral wall without requiring dismantling of any part of the power circuit.

2. The electrical power distribution assembly of claim 1, the vessel further comprising a bail handle.

3. The electrical power distribution assembly of claim 1, wherein the at least one power socket comprises a plurality of power receptacles.

4. The electrical power distribution assembly of claim 3, wherein the power socket and the power receptacles are mounted to the peripheral wall.

5. The electrical power distribution assembly of claim 1, wherein the power socket and the power receptacles are mounted to the lid.

6. The electrical power distribution assembly of claim 1, wherein the power receptacle includes an electric circuit protective device.

7. The electrical power distribution assembly of claim 6, wherein the electric circuit protective device is a ground fault interrupter.

8. The electrical power distribution assembly of claim 1, further comprising, for each power receptacle, an associated electrical work box mounted in the interior to at least one of the peripheral wall and the lid, with one power receptacle installed within its associated electrical work box.

9. The electrical power distribution assembly of claim 1, further comprising:
a first power circuit including a power socket mounted to the lid, at least one power receptacle mounted to the lid, and power conductors establishing continuity between the power socket and each power receptacle; and
a second power circuit including a power socket mounted to the peripheral wall of the vessel, at least one power receptacle mounted to the peripheral wall of the vessel, and power conductors establishing continuity between the power socket and each power receptacle.

10. The electrical power distribution assembly of claim 1, wherein the electrically conductive prongs of the power socket are recessed below an outer surface of the vessel.

11. The electrical power distribution assembly of claim 1, further comprising a water resistant cover which overhangs the vessel and has clips disposed to engage the lid of the vessel.

12. The electrical power distribution assembly of claim 1, further comprising a translucent, liquid resistant cover which is configured to fit to the vessel by friction.

13. A modular electrical power distribution assembly, comprising a plurality of electrical power modules which modules are configured to interengage one another to form a vertical stack of plural electrical power modules, wherein each electrical power module comprises:
a vessel having a floor, a peripheral wall projecting upwardly from the floor, an open interior above the floor and within the peripheral wall, and a lid which removably frictionally engages the peripheral wall to close the open interior;
a power socket mounted to a selected one of the the peripheral wall and the lid, the power socket including electrically conductive prongs exposed to the exterior of the vessel for ready installation of a female terminal of a power conductor;
at least one power receptacle mounted to the selected one of the lid and the peripheral wall, the power receptacle including recessed power conductors exposed to the exterior of the vessel for ready insertion of a male power terminal of an electrical supply cord; and
power conductors establishing a power circuit electrically connecting the power socket to each power receptacle, the power conductors contained within the vessel, wherein the power socket, the power receptacle, and the power conductors of any one power circuit are mounted to only one of the peripheral wall and the lid, thereby enabling the lid to be removed from the peripheral wall without requiring dismantling of any part of the power circuit.

14. The modular power distribution assembly of claim 13, further comprising a base module comprising a vessel devoid of electrical circuitry, for receiving ballast weights.

15. A method of providing temporary power distribution, comprising:
installing a power socket in a vessel, with the power socket exposed for manual installation of a supply power cord thereto from the exterior of the vessel;
installing a plurality of power receptacles in the vessel, with the power receptacles exposed for manual connection of power cords of electrical appliances thereto from the exterior of the vessel;
establishing a power circuit operably connecting the power receptacles to the power socket;
orienting the vessel on a supporting environmental surface with the open end of the vessel facing upwardly;
placing at least one ballast weight in the vessel; and
installing an energized power cord in the power socket.
